(19) United States
(12) Patent Application Publication
(10) Pub. No.: US 2015/0308159 A1
(43) Pub. Date: Oct. 29, 2015

(54) Thermoplastic Security Seal with Covered Locking Recess

(71) Applicants: Chrisotpher Benning, Greenhithe (GB); Samuil Blonden, Plymouth (GB)

(72) Inventors: Chrisotpher Benning, Greenhithe (GB); Samuil Blonden, Plymouth (GB)

(73) Assignee: E. J. Brooks Company, Congers, NY (US)

(21) Appl. No.: 14/672,387

(22) Filed: Mar. 30, 2015

Related U.S. Application Data
(60) Provisional application No. 61/978,303, filed on Apr. 11, 2014.

(51) Int. Cl. E05B 73/00; E05C 19/08

(52) U.S. Cl. CPC E05B 73/00; E05C 19/08

(57) ABSTRACT

A security seal includes a molded one piece body and a cover disc. The body has a cylindrical chamber for receiving the disc. A locking recess is formed in the body in communication with the chamber and defined in part by a locking shoulder. The cover is secured to the body in the chamber to enclose the locking recess. The disc is separated from the body when enclosing the chamber. A rotatable arm is attached to an extension member extending from the body via a hinge. The free end of the arm has an arrow shaped locking element attached that engages the recess locking shoulder when inserted into the recess. The locking element has a resilient tang member that is compressed by the locking shoulder and which tang member returns to its acquiescent state when fully inserted into the recess thereby locking the tang member in the recess. The cover has posts that extend through mating bores in the body, the protruding ends of the posts are deformed to preclude withdrawal of the posts from the bores to thereby lock the cover to the body.

This invention claims priority on U.S. provisional application No. 61/978.303 filed Apr. 11, 2014 in the name of Chistopher Benning et al. incorporated by reference in its entirety herein and relates to thermoplastic molded security seals with improved manufacturing cost effectiveness.

Security seals have numerous sizes, shapes and elements that differ in many different ways from each other. Many such seals may be metal, plastic or combination of different materials. The present invention relates particularly to a molded thermoplastic security seal of the type having a locking chamber and a mating locking element which together form a locked close loop for securing a hasp and the like. The locking element or the locking chamber may include a resilient tang or locking member that mates by compressively bending the resilient tang or locking member during insertion into the locking chamber and which locking member returns to its quiescence position in the locked state.

Commonly owned U.S. Pat. No. 5,522,627 ('627) to Swift, incorporated by reference in its entirety herein, discloses a molded thermoplastic security seal similar to the type of seal according to the present invention. The prior art seal, however, is different and comprises a molded thermoplastic housing body to which a movable leg is attached that is resiliently rotatable including a molded spring at the hinge region of the leg-body interface and a second rigid non-movable leg also attached to the body and spaced from the movable leg. A socket is secured to the extended free end of the movable leg and having a locking cavity with internal flexible locking fingers. The free end of the rigid leg has a stud locking element that engages and locks to the locking cavity via internal flexible locking fingers in the socket chamber which resiliently flex to receive the locking stud element. The housing body from which the movable and rigid legs extend is solid. This seal is successful. But it also has problems.

This seal tends to be costly in that it requires multiple molds during its manufacturing process and subsequent assembly of the parts. These seals compete in competitive markets and, therefore, cost is critical. A need is seen to provide a similar seal at lower cost.

Seals similar to the '627 type of seal are disclosed in commonly owned U.S. Pat. Nos. 5,116,091; 4,506,921; 4,319,776; 4,441,233 and 4,588,218 among others.

The problem present with the prior art seals is recognized by the present inventors as lying in the process of molding such plastic seals. They recognize that such seals may be produced at lower cost if the number of molds can be reduced to a single mold.

Another problem is that such chambers need to be fully enclosed so that a tamperer does not have access to the locked locking element inside the locking chamber. The prior art as exemplified by the above patents approach this problem with specific designs of the locking arrangements of the seals. These arrangements tend to be costly to produce.

A need is seen for a lower cost mass produced thermoplastic seal of the type described above, and importantly, which, at the same time, provides effective evidence of tampering while solving the problem of molding the seal in an efficient mass produced manner. Evidence of tampering is also important in these types of seals.

A security seal according to an embodiment of the present invention comprises a housing body having a locking recess, the recess having an opening for receiving a mating seal locking element; the recess having a region normally exposed to the ambient atmosphere facing in a given direction from the body; a cover secured to the body over the locking recess for enclosing the recess; an arm extending from the body arranged so that at least a portion of the arm can move relative to the body; the locking element being attached to the arm for engaging the locking recess, the recess and the locking element being arranged to cooperatively lock the received element within the recess so that the locked arm and body forms a locked hasp receiving loop; and a cover locking arrangement for securing the cover to the body.

In a further embodiment, the body has a chamber overlying and in communication with the recess, the cover for being received in the chamber.

In a further embodiment, the cover and body are initially molded as one piece thermoplastic and the cover then separated from the body for attachment over the recess.

In a further embodiment, the chamber is circular and frusto-conical, the cover is a frusto-conical disc that closely mates with the chamber, the body and cover each having a chamfered rim mating with one another, encircling and enclosing the chamber.

In a further embodiment, the body is partially circular cylindrical and partially rectangular.

In a further embodiment, the body defines a plane, the body being of such small size so as to substantially preclude receiving bar code identification indicia, further including an extension member extending from the body, the arm extending from the extension member, the arm, body and extension member being coplanar, the extension member for receiving the bar code identification indicia.

In a further embodiment, the body defines a plane, further including an extension member extending from the body for receiving bar code Identification indicia, the arm extending from the extension member, further including a stanchion attached to the extension member, the arm extending from the stanchion and being movable relative to the stanchion, the arm, the body and extension member being coplanar.

In a further embodiment, the body includes an extension member extending from the body for receiving bar code Identification indicia, the arm extending from the extension member.

In a further embodiment, an extension member extends from the body for receiving bar code Identification indicia, the arm extending from the extension member, further including a stanchion attached to the extension member, the arm extending from the stanchion, and a hinge connecting the arm to the stanchion.

In a further embodiment, the cover is a disc having at least one post extending therefrom, the body having at least one bore arranged to receive the at least one post there through, the post having a portion extending beyond the body, and which portion is deformed to preclude withdrawal of the post and cover from the body, locking the cover to the body.

In a further embodiment, the cover is a circular disc having a chamfered rim and at least one post extending substantially normal to and from the cover, the body including a chamber for receiving the cover, the recess being located in communication with the chamber, the body having at least one bore in communication with the chamber arranged to receive the at least one post, and a locking arrangement for locking the cover to the body.

In a further embodiment, the cover is a circular disc having a chamfered rim, the body having a chamber for receiving the cover, the chamber having a chamfered rim for engaging the received disc chamfered rim, the locking recess being in communication with the chamber, and an arrangement for locking the cover to the body in the body chamber.

In a further embodiment, the cover is a fruto-conical disc having a chamfered rim and a plurality of posts extending from the cover, the body having a chamber in communication with the locking recess and having a plurality of bores arranged to receive respective ones of the posts, the posts and body being arranged for locking the posts and the cover to the body.

### IN THE DRAWING

FIG. 1 is an isometric top view of a security seal with a locking recess enclosed by a cover in the seal unlocked state with a rotatable elongated arm having a locking element extending from its free end for locking engaging a mating element associated with the recess;

FIG. 2 is a top plan view of the seal of FIG. 1 without the recess cover in place in the unlocked state;

FIG. 3 is a cross sectional elevation view of the seal of FIG. 2 taken along lines 3-3 of FIG. 2;

FIG. 4 is a an isometric top view of the seal similar to the view of FIG. 1 without the locking recess cover locked in place as in FIG. 1, but instead with the cover attached to the seal body and arm assembly in the as molded state as a one piece unit;

FIG. 5 is a side elevation view of the locking recess cover in the locked state for enclosing the locking recess;

FIG. 6 is an isometric bottom view of the seal of FIG. 4 locking body and cover portion showing posts for locking the cover to the seal body for permanently enclosing the locking recess;

FIG. 7 is a top plan view of the seal of FIG. 1 without the cover in place in the seal locked state prior to the securing of the cover to the seal body;

FIG. 8 is a partial sectional elevation view of the seal of FIG. 1 taken through two of the bores and inserted posts attached to the cover;

FIG. 9 is a sectional view similar to that of FIG. 8 but with the protruding post portions crushed and deformed to lock the cover to the seal body in the final form of the seal;

FIG. 10 is a bottom plan view of the seal of FIG. 7;

FIG. 11 is an isometric side view of a seal according to a further embodiment of the present invention with the cover attached to the body over the locking recess, but not secured locked to the body; and

FIG. 12 is a top plan view of the seal of FIG. 11 in the one piece as molded state prior to the separation of the cover from the body.

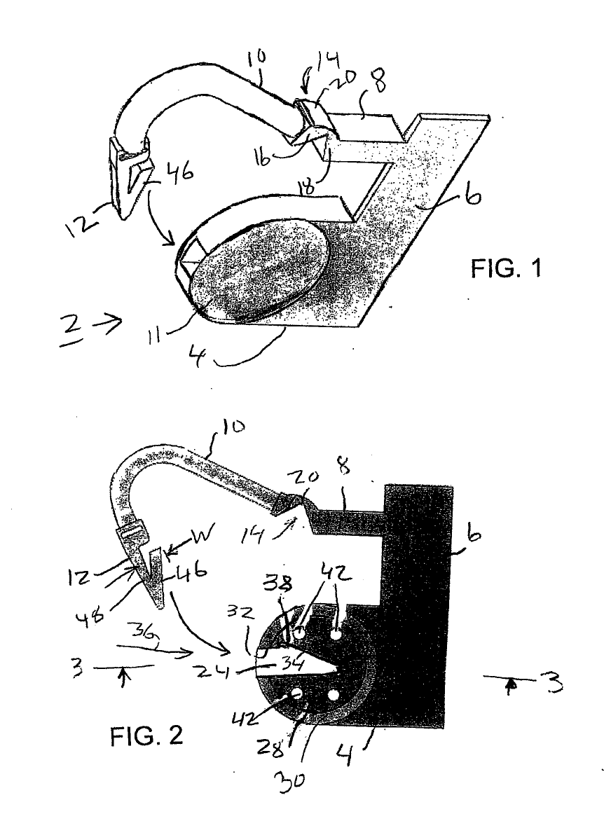

In FIG. 1, seal 2 according to one embodiment of the present invention, comprises a body 4, an extension 6, an upstanding stanchion 8, an arm 10, a cover 11 and a locking element 12. The arm 10 is movably secured to the stanchion 8 by a living hinge 14. A living hinge is plastic material that is made sufficiently thin so that it can flex at its narrowest location between two hinge portions. For example hinge 14 has portions 16 and 18 connected to a relatively thin section 20 that permits the portions 18 and 18 to move relative to one another.

Extension 6 is an elongated flat member of relatively thin cross section and preferably rectangular. The extension could be of any size or shape. However, the extension 6 is shaped and sized to receive bar code identification indicia or other indicia (not shown). The extension 6 is provided as the body 4 is only about 20 mm in in diameter in this embodiment and which is too small an area to receive the desired bar code or other desired indicia. Such other indicia may include imprinting the extension with the seal manufacturer name or other information as may be desired in a given implementation.

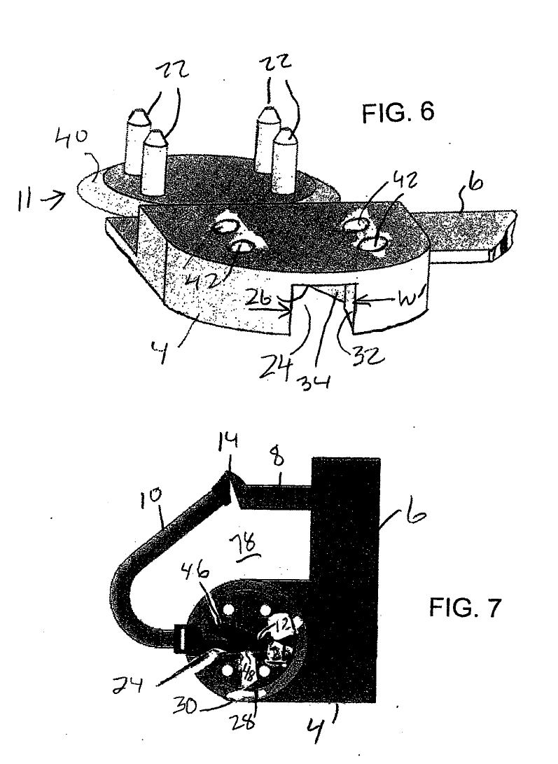

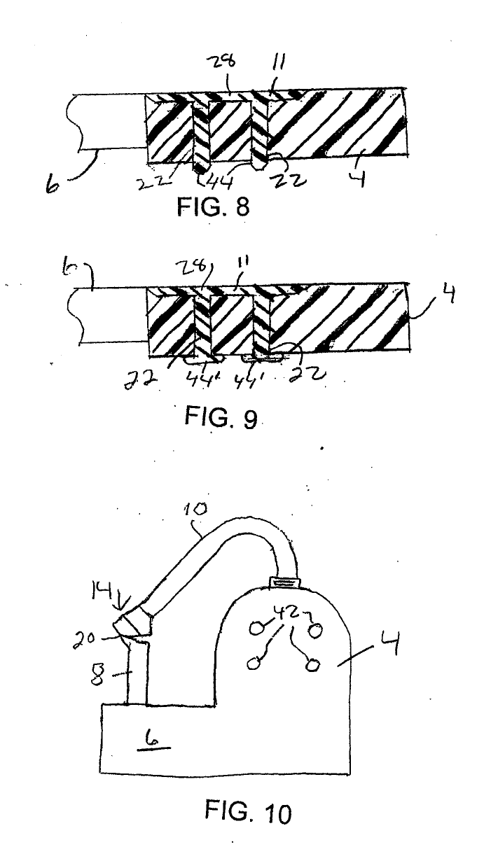

In FIG. 4, the cover 11 is molded simultaneously with and one piece with the body 4. The cover 11 has four molded upstanding like posts 22, FIG. 6, which could be different than shown if desired in shape and configuration (not shown). When the cover 11 is employed in the final seal configuration FIGS. 1, 9, for example, it is separated from the body 4 (FIG. 4) at junction 13 so the body 4 no longer has the cover 11 attached, but rather becomes a separate and independent piece from the body 4, FIGS. 8 and 9. In FIGS. 2, 3 and 4, the body 4 is molded with a locking recess 24 that is in communication with the bottom surface 26 of chamber 28.

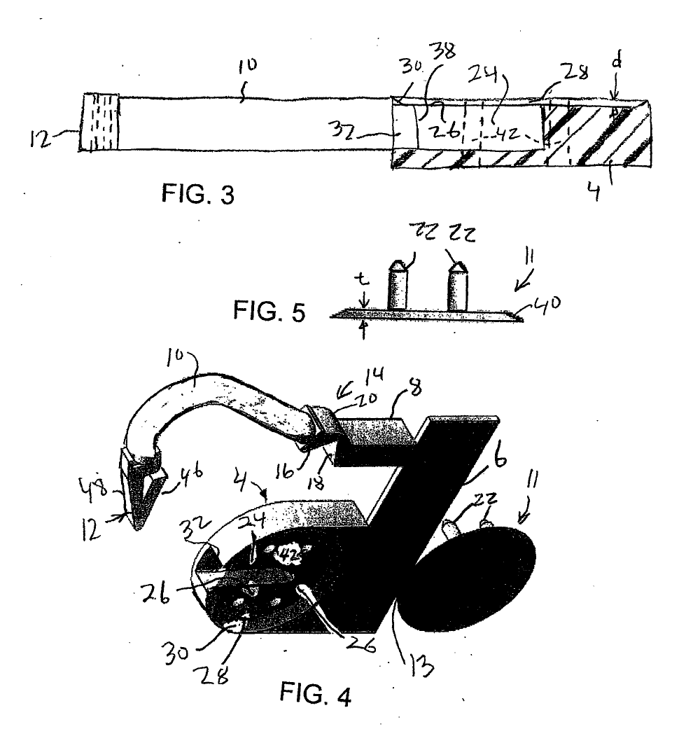

Chamber 28 is shallow, having a depth d, FIG. 3, the same as the thickness t of the cover 11, FIG. 5. The chamber 28 closely receives the cover 11, FIGS. 8 and 9. The chamber 28 has a circular chamfered side wall 30 forming a frusto-conical chamber 28, that mates with the chamfered side wall 40 of the cover 11, FIG. 5. The chamfered side walls serve to guide the cover in place into the chamber 28 by a robot (not shown). The robot (not shown) also separates the cover 11 from the body 4 while they are still in the mold (not shown).

The locking recess 24 has an egress opening 32, FIGS. 2, 4 and 6. The recess 24 is arrow shaped to match the shape of the locking element 12. Recess 24 has a side wall 34 tapered at an angle to the insertion direction 36 of the locking element 12, attached to the arm 10. The tapered side wall 34 terminates at locking shoulder 38 in the recess 24. Locking shoulder 38 captures the tang 46 of the locking element 12, FIGS. 4 and 7, to lock the element 12 in the recess 24.

The body 4 has four identical through bores 42, as best seen in FIGS. 2 and 6. The bores 42 are formed in surface 26 and pass entirely through the body 4 in communication with the chamber 28. The bores 22 closely receive the respective posts 22, FIG. 6.

In FIGS. 8 and 9, the cover 11 is located in the chamber 28 and closely received therein with the chamfered sides mating as shown. The posts 22 are in the bores 42 and have a portion 44 that protrudes from the bores and the body 4 on the body side opposite the chamber 28. In FIG. 9, the portions 44 are deformed forming crushed portions 44′. The mold (not shown) is arranged to crush the post portions 44 after the robot (not shown) detaches the cover 11 from the body and inserts the cover into the mating chamber 28 and the posts 22 into the mating bores 42 in a manner not shown. This procedure saves the use of an additional mold to form the seal as in the prior art seals. The chamfered sides of the cover 11 and the chamber 28 serve to guide the insertion of the cover 11 into the chamber 28 by a robot (not shown).

In FIG. 1, the locking element 12 is arrow shaped with a resilient tang 46, The resilient tang 46 forms an arrow with a rigid tang 48. The width w of the two tangs, FIG. 2, is larger than the corresponding width w′ of the opening 32, FIG. 6, to the recess 24. This results in the compression of the tang 46 toward tang 48 as the element 12 is inserted into the opening 32. Once inserted, the tang 44 inside the recess 24 returns to its quiescent state, FIG. 7. The shoulder 38 formed by the body at the recess opening 32 engages the inserted tang 46 precluding it from being withdrawn from the recess, locking the arm free end, locking element 12, to the body 4. The locked locking element and arm 10 thus forms a closed locked loop 78, FIG. 7, with the extension 6, stanchion 8, and body 4 for securing a hasp, for example.

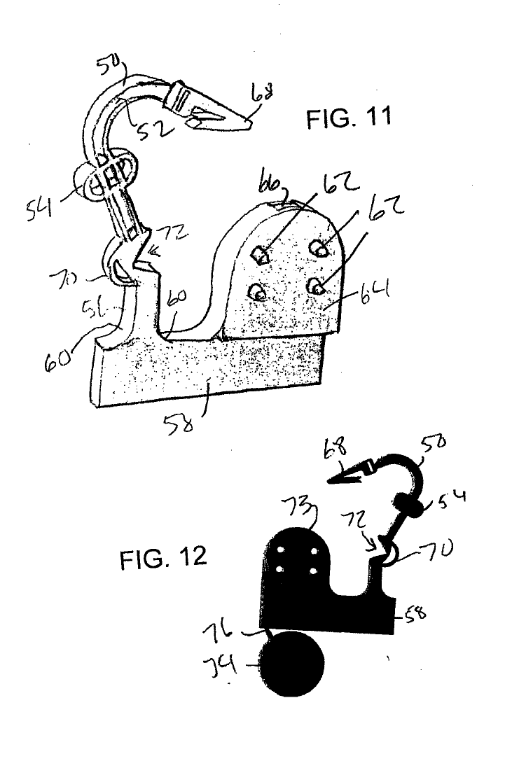

FIGS. 11 and 12 show an alternate embodiment of a seal according to the present invention. In FIG. 11 the arm 50 has a channel 52 to reduce the amount of material used to make the seal. The arm 50 also has an oval transverse member 54, also with a channel therein, at the arm midsection. The stanchion 56 is secured to extension 58 with an enlarged reinforcing filet 60 having a relatively large radius. Posts 62 attached to the cover (not shown in this figure) protrude from the seal body bottom region 64 (FIG. 8). The locking recess (not shown) has an egress opening 66. Locking element 68 is arrow shaped as described above. A spring member 70 is attached over the hinge 72. This is shown in the prior art '627 patent. This member provides tamper evidence as once severed, it can not be restored to its original resiliency. The disc shaped cover 74 in this embodiment is attached to the seal body 73 by a narrow in cross section elongated member 76 to provide ease of separation of the cover 74 from the body 73.

It will occur to those of ordinary skill that modifications may be made to the disclosed embodiments. For example, the disclosed body, locking arm and locking element, the configuration and orientation of the various disclosed elements, their materials, dimensions, and overall configurations may differ from those disclosed herein. For example, the cover could be welded to the body at its rim and the posts omitted. However, this embodiment would not be as desirable, as the welds might be tampered with and glued in place later in an undetectable manner. The deformed posts, however, provide improved tampering evidence as any tampering therewith would destroy the deformed region making it readily observable as being tampered with. The preferred embodiment disclosed herein is given by way of illustration and not limitation. Such modifications are intended to be included in the scope of the present invention as defined by the appended claims.

What is claimed is:

1. A security seal comprising:
a housing body having a locking recess, the recess having an opening for receiving a mating seal locking element;
the recess having a region facing in a given direction from the body exposed to the ambient atmosphere;
a cover secured to the body over the locking recess for enclosing the recess;
an arm extending from the body arranged so that at least a portion of the arm can move relative to the body;
the locking element being attached to the arm for engaging the locking recess, the recess and the locking element being arranged to cooperatively lock the received element within the recess so that the locked arm and body forms a locked hasp receiving loop; and
a cover locking arrangement for securing the cover to the body.

2. The security seal of claim 1 wherein the body has a chamber overlying and in communication with the recess, the cover for being received in the chamber.

3. The security seal of claim 1 wherein the cover and body are initially molded as one piece thermoplastic and the cover then separated from the body for attachment over the recess.

4. The security seal of claim 2 wherein the chamber is circular and frusto-conical, the cover is a frusto-conical disc that mates with the chamber, the body and cover each having a chamfered rim mating with one another, encircling and enclosing the chamber.

5. The security seal of claim 1 wherein the body is partially circular cylindrical and partially rectangular.

6. The security seal of claim 1 wherein the body defines a plane, the body being of such size so as to substantially preclude receiving bar code identification indicia, further including an extension member extending from the body, the arm extending from the extension member, the arm, body and extension member being coplanar, the extension member for receiving the bar code indicia

7. The security seal of claim 1 wherein the body defines a plane, further including an extension member extending from the body for receiving bar code Identification indicia, the arm extending from the extension member, further including a stanchion attached to the extension member, the arm extending from the stanchion and being movable relative to the stanchion, the arm, the body and extension member being coplanar.

8. The security seal of claim 1 wherein the body includes an extension member extending from the body for receiving bar code Identification indicia, the arm extending from the extension member.

9. The security seal of claim 1 including an extension member extending from the body for receiving bar code Identification indicia, the arm extending from the extension member, further including a stanchion attached to the extension member, the arm extending from the stanchion, and a hinge connecting the arm to the stanchion.

10. The security seal of claim 1 wherein the cover is a disc having at least one post extending therefrom, the body having at least one bore arranged to receive the at least one post there through, the post having a portion extending beyond the body, and which portion is deformed to preclude withdrawal of the post and cover from the body, locking the cover to the body.

11. The security seal of claim 1 wherein the cover is a circular disc having a chamfered rim and at least one post extending substantially normal to and from the cover, the body including a chamber for receiving the cover, the recess being located in communication with the chamber, the body having at least one bore in communication with the chamber arranged to receive the at least one post, and a locking arrangement for locking the cover to the body.

12. The security seal of claim 1 wherein the cover is a circular disc having a chamfered rim, the body having a chamber for receiving the cover, the chamber having a chamfered rim for engaging the received disc chamfered rim, the locking recess being in communication with the chamber, and an arrangement for locking the cover to the body in the body chamber.

13. The security seal of claim 1 wherein the cover is a frusto-conical disc having a chamfered rim and a plurality of posts extending from the cover, the body having a chamber in communication with the locking recess and having a plurality of bores arranged to receive respective ones of the posts, the posts and body being arranged for locking the posts and the cover to the body.
